(19) United States
(12) Patent Application Publication
(10) Pub. No.: US 2025/0182710 A1
(43) Pub. Date: Jun. 5, 2025

(54) BACKLIGHT DEVICE FOR DISPLAY AND CURRENT CONTROL INTEGRATED CIRCUIT THEREOF

(71) Applicant: Global Technologies Co., Ltd., Hwaseong-si, Gyeonggi-do (KR)

(72) Inventors: Yong Geun KIM, Suwon-si, Gyeonggi-do (KR); Min Seon KIM, Hwaseong-si, Gyeonggi-do (KR)

(73) Assignee: Global Technologies Co., Ltd., Hwaseong-si, Gyeonggi-do (KR)

(21) Appl. No.: 18/843,181

(22) PCT Filed: Jan. 27, 2023
(86) PCT No.: PCT/KR2023/001278

§ 371 Date: Aug. 30, 2024

(30) Foreign Application Priority Data
Mar. 3, 2022 (KR) 10-2022-0027508

(51) Int. Cl. G09G 3/34

(52) U.S. Cl. CPC G09G 3/3426; G09G 2320/0233; G09G 2320/0247; G09G 2320/0633; G09G 2320/064; G09G 2320/0646

(57) ABSTRACT

Disclosed are a backlight device for a display that provides a backlight for displaying an image and a current control integrated circuit thereof. According to the backlight device and the current control integrated circuit thereof, a driving current can be controlled so as to allow light emitting blocks to maintain light emission for one frame or more, and the luminance of a backlight can be uniformly and precisely controlled in an entire luminance change area.

### BACKGROUND

### 1. Field

Exemplary embodiments relate to a backlight device for a display, and more particularly, to a backlight device for a display that provides a backlight for displaying an image and a current control integrated circuit thereof.

### 2. Discussion of the Related Art

Among display panels, for example, an LCD panel requires a backlight device to display images.

The backlight device is intended to provide a backlight for displaying images on an LCD panel, and the LCD panel may display images by using the backlight by performing an optical shutter operation for each pixel.

The backlight device may include a backlight board coupled to the LCD panel. The backlight board may include light emitting blocks using LEDs as light sources, and the light emitting blocks may emit light to provide a backlight.

The backlight board may include light emitting blocks to provide a backlight with a resolution different from that of the image of the LCD panel, and each light emitting block may be configured so that its dimming is controlled.

A backlight device in the related art that performs dimming control has a difficulty in maintaining light emission of light emitting blocks for one frame. When the light emitting blocks do not sufficiently maintain light emission for one frame, a flicker may occur in the backlight. Therefore, the backlight device needs to adopt a design for reducing or eliminating the flicker.

The backlight device also needs to be configured to precisely control the luminance of the backlight over an entire luminance change area. That is, the luminance change needs to be uniformly controlled in a low luminance area where light is emitted using a small amount of current and a high luminance area where light is emitted using a large amount of current.

### SUMMARY

Various embodiments are directed to providing a backlight device for a display and a current control integrated circuit thereof that can reduce or eliminate a flicker in a backlight provided to an LCD panel for a display by allowing light emitting blocks to maintain light emission for one frame or more.

Various embodiments are directed to providing a backlight device for a display and a current control integrated circuit thereof that can uniformly and precisely control the luminance of a backlight over an entire luminance change area.

Various embodiments are directed to providing a backlight device and a current control integrated circuit thereof that can uniformly control the luminance over an entire luminance change area by controlling the amount of driving current for a backlight through a combination of linear control and pulse width control.

A backlight device for a display of the present disclosure may include: a backlight driving board configured to generate frame-unit backlight data for a backlight and to provide, for each horizontal period, a first column signal and a second column signal corresponding to column data of the backlight data and a row signal corresponding to the horizontal period; and a backlight board configured to control the backlight by the first column signal, the second column signal, and the row signal provided for each horizontal period, wherein the backlight board includes: light emitting blocks configured to form columns and rows and to be grouped into a plurality of control units each including a plurality of rows; and current control integrated circuits configured for each control unit and each including a plurality of driving current control units configured to receive the first column signal and the second column signal shared by the light emitting blocks of a same column and the row signals corresponding to the plurality of rows, respectively, and, the driving current control unit samples the first column signal and the second column signal by using the row signal, and controls an amount of driving current for light emission of the light emitting block to correspond to a pulse width corresponding to a level of a first sampled signal obtained by sampling the first column signal and a level of a second sampled signal obtained by sampling the second column signal.

A current control integrated circuit of a backlight device for a display of the present disclosure may include: a plurality of driving current control units configured to correspond to light emitting blocks in control units each including a plurality of rows, to share a first column signal and a second column signal with respect to a same column, and to receive different row signals, wherein each of the driving current control units samples the first column signal and the second column signal by using the row signal, and controls an amount of driving current for light emission of the light emitting block to correspond to a pulse width corresponding to a level of a first sampled signal obtained by sampling the first column signal and a level of a second sampled signal obtained by sampling the second column signal.

The present disclosure can be expected to have the effect that light emitting blocks for providing a backlight to a display panel for a display can maintain light emission for one frame or more and provide a backlight with a reduced or eliminated flicker.

The present disclosure can also be expected to have the effect that the luminance of a backlight provided in a panel for a display can be uniformly and precisely controlled in an entire luminance change area.

The present disclosure can also be expected to have the effect that the luminance of an entire luminance change area can be uniformly controlled by controlling the amount of driving current for a backlight through a combination of linear control and pulse width control.

### BRIEF DESCRIPTION OF THE DRAWINGS

FIG. 1 is a block diagram illustrating an embodiment of a backlight device for a display of the present disclosure.

FIG. 2 is a block diagram illustrating an embodiment of a backlight driving board in FIG. 1.

FIG. 3 is a waveform diagram illustrating a first column signal, a second column signal, and a row signal in FIG. 1.

FIG. 4 is a block diagram illustrating a backlight board in FIG. 1.

FIG. 5 is a block diagram illustrating the electrical connection relationship between a current control integrated circuit in FIG. 4 and light emitting blocks.

FIG. 6 is a block diagram illustrating an embodiment of the current control integrated circuit in FIG. 4.

FIG. 7 is a graph illustrating the correlation between the first column signal and a driving current.

FIG. 8 is a graph illustrating the correlation between the second column signal and a driving current.

FIG. 9 is a diagram illustrating the arrangement of light emitting blocks and control units.

FIG. 10 is a block diagram illustrating an embodiment of a driving current control unit in FIG. 6.

FIG. 11 is a detailed circuit diagram illustrating an embodiment of sample and hold units in FIG. 10.

FIG. 12 is a block diagram illustrating an embodiment of a PWM conversion circuit.

### DETAILED DESCRIPTION

Hereinafter, preferred embodiments of the present disclosure are described in detail with reference to the accompanying drawings. The terms used in this specification and claims are not interpreted as being limited to typical or dictionary definitions, but should be interpreted as meanings and concepts which coincide with the technical idea of the present disclosure.

Since an embodiment described in the present specification and configurations illustrated in the drawings are preferred embodiments of the prevent disclosure and do not represent all the technical scopes of the prevent disclosure, there may be various equivalents and modification examples which can substitute for them at the time of application of the prevent disclosure.

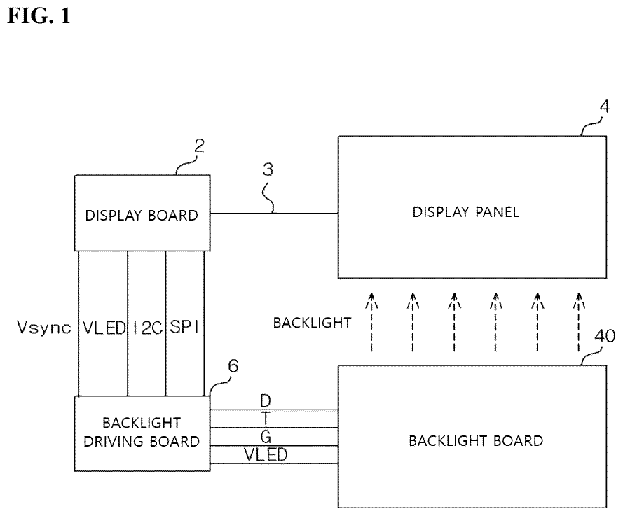

A display device for displaying an image may be illustrated as including a display board 2, a display panel 4, a backlight driving board 6, and a backlight board 40 as illustrated in FIG. 1.

In the above configuration, it can be understood that the backlight driving board 6 and the backlight board 40 correspond to a backlight device.

The backlight device is used to provide a backlight for displaying images on the display panel 4. The backlight is configured to be provided from the backlight board 40 to the display panel 4. The backlight board 40 may include light emitting blocks for providing a backlight and current control integrated circuits.

The configuration and function of the display device for displaying an image are described below with reference to FIG. 1.

In order to display an image, the display board 2 and the display panel 4 may be used.

The display panel 4 may be configured using an LCD panel, and is configured to receive display data from the display board 2 through a transmission line 3 and to display an image in response to the display data.

The display panel 4 includes pixels (not illustrated) for implementing a pre-designed resolution, and each pixel performs an optical shutter operation in response to the display data. The display panel 4 may display an image using a backlight by the above-described optical shutter operation of the pixels.

The display board 2 is configured to receive data from a video source (not illustrated), generate display data for displaying an image by using the received data, and provide the display data to the display panel 4 through the transmission line 3.

For the transmission of the display data described above, the display board 2 may include components (not illustrated) for configuring display data into packets and components for providing the display data including the packets to the display panel 4. Since the components for configuring the display data into the packets correspond to timing controllers used in general display devices, a description thereof is omitted.

The display data may be configured to display images in units of frames. For example, the display data may include data indicating the brightness of a pixel, a vertical synchronization signal Vsync that divides frames according to a frame period, a horizontal synchronization signal that divides the horizontal periods of the frame, and the like.

The configuration and function of the backlight device for providing a backlight to the display panel 4 are described below with reference to FIG. 1.

The display board 2 may provide luminance data SPI corresponding to frame-unit display data to the backlight driving board 6.

The resolution of an image displayed on the display panel 4 and the resolution of the backlight provided to the display panel 4 from the backlight board 40 may be different from each other. The gray range and gray value of the backlight may also be different from those for images.

Therefore, the display board 2 may be configured to provide luminance data SPI converted to be suitable for the resolution, the gray range, and the gray value of the backlight by using the display data. To this end, the display board 2 can be understood as including a conversion circuit (not illustrated) for converting the display data into the luminance data SPI.

The display board 2 may configure the luminance data SPI in a format that can be received by the backlight driving board 6, and provide the luminance data SPI to the backlight driving board 6.

The display board 2 may provide a dimming mode command I2C to the backlight driving board 6 in order to set a dimming mode for the backlight corresponding to a displayed image. For example, the dimming mode command I2C may include information defining a dimming mode as one of linear control, pulse width control, and composite control.

The linear control can be understood as controlling the amount of driving current for the backlight by using a control signal having a level corresponding to a change in luminance, and the pulse width control can be understood as controlling the amount of driving current for the backlight by using a control pulse having a pulse width corresponding to a change in luminance. The composite control is a combination of the linear control and the pulse width control, and can be understood as controlling the amount of driving current for the backlight by complexly using the control signal having a level corresponding to a change in luminance and the control pulse having a pulse width corresponding to a change in luminance.

The display board 2 may provide the vertical synchronization signal Vsync to the backlight driving board 6 through a separate transmission line.

The display board 2 may provide a driving voltage VLED for driving the backlight to the backlight driving board 6. The driving voltage VLED can be understood as a voltage to be provided to light emitting blocks to be described below.

The backlight driving board 6 receives the luminance data SPI, the vertical synchronization signal Vsync, the dimming mode command I2C, and the driving voltage VLED from the display board 2.

The backlight driving board 6 may be configured to generate frame-unit backlight data for the backlight by using frame-unit luminance data SPI corresponding to the display data, and provide, for each horizontal period, a first column signal D and a second column signal T having a level corresponding to backlight data and a row signal G corresponding to the horizontal period. The backlight driving board 6 may be configured to provide first column data with values for the linear control and second column data with values for the pulse width control in response to the backlight data for each horizontal period. Therefore, the first column signal D may correspond to the first column data for each horizontal period of the backlight data and have a level for the linear control, and the second column signal T may correspond to the second column data for each horizontal period of the backlight data and have a level for the pulse width control. In an embodiment of the present disclosure, the backlight data can be understood to mean frame-by-frame data, and the column data can be understood to mean horizontal period-by-horizontal period data of the backlight data. In response to the same horizontal period of the backlight data, the first column signal D based on the first column data and the second column signal T based on the second column data may be provided at the same level or different levels.

The backlight driving board 6 may output the first column signal D and the second column signal T for the linear control, the pulse width control, or the composite control by the dimming mode command I2C.

In response to the dimming mode command I2C for the linear control, the backlight driving board 6 may provide the first column signal D having a level for the linear control of the amount of driving current for light emission in response to horizontal period-by-horizontal period first column data of the backlight data, and provide the second column signal T fixed at a preset level in response to the second column data having a preset value.

In response to the dimming mode command I2C for the pulse width control, the backlight driving board 6 may provide the first column signal D fixed at a preset level in response to the first column data having a preset value, and provide the second column signal T having a level for the pulse with control of the amount of driving current for light emission in response to horizontal period-by-horizontal period second column data of the backlight data.

In response to the dimming mode command I2C for the composite control, the backlight driving board 6 may provide the first column signal D having a level for the linear control in response to the horizontal period-by-horizontal period first column data of the backlight data and the second column signal T having a level for the pulse width control in response to the horizontal period-by-horizontal period second column data of the backlight data.

Subsequently, the backlight driving board 6 may transmit the driving voltage VLED received from the display board 2 to the backlight board 40.

As described above, the backlight driving board 6 may output the first column signal D, the second column signal T, the row signal G, and the driving voltage VLED to the backlight board 40.

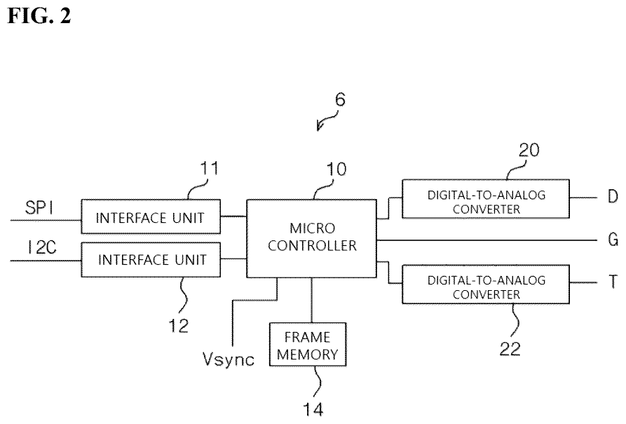

The above-described backlight driving board 6 may be described with reference to FIG. 2.

The backlight driving board 6 may include a microcontroller 10, interface units 11 and 12, a frame memory 14, and digital-to-analog converters 20 and 22.

The interface unit 11 is configured to receive the luminance data SPI and provide the luminance data SPI to the microcontroller 10. The interface unit 12 is configured to receive the dimming operation mode command I2C and provide the dimming operation mode command I2C to the microcontroller 10. The interface units 11 and 12 can be understood as serving as a buffer for the transmission of digital signals.

The microcontroller 10 is configured to receive the frame-unit luminance data SPI corresponding to the display data, the dimming operation mode command I2C, and the vertical synchronization signal Vsync, to generate the frame-unit backlight data for the backlight by using the luminance data SPI, and to output, for each horizontal period of the frame, the horizontal period-by-horizontal period first column data and second column data of the backlight data. The microcontroller 10 may distinguish the horizontal period-by-horizontal period column data from the backlight data by synchronization using the vertical synchronization signal Vsync, and provide the first column data and the second column data for the linear control, the pulse width control, and the composite control as the above-described column data.

The microcontroller 10 may distinguish the luminance data SPI in units of frames by using the vertical synchronization signal Vsync, distinguish horizontal periods included in the frame by synchronization using the vertical synchronization signal Vsync, and output a horizontal period-by-horizontal period row signal G. The microcontroller 10 may be configured to provide the above-described row signal G to the backlight driving board 6. The row signal G can be understood as a pulse having a preset pulse width and amplitude.

From the above, the synchronization using the vertical synchronization signal Vsync may be implemented in various ways, such as counting or delay synchronized with the vertical synchronization signal Vsync, and may be performed in various ways by those who understand the technology of the present disclosure. Therefore, examples and descriptions of specific embodiments thereof are omitted.

The microcontroller 10 may provide the digital-to-analog converters 20 and 22 with the horizontal period-by-horizontal period first column data and second column data generated as described above.

The digital-to-analog converter 20 may be configured to receive the horizontal period-by-horizontal period first column data, and output an analog first column signal D having a level for the linear control to the backlight board 40 in response to the value of the first column data. In the case of the pulse width control, the digital-to-analog converter 20 may receive the first column data having a preset fixed value and output the first column signal D having a fixed level to the backlight board 40.

In addition, the digital-to-analog converter 22 may be configured to receive the horizontal period-by-horizontal period second column data, and output an analog second column signal T having a level for the pulse width control to the backlight board 40 in response to the value of the second column data. In the case of the linear control, the digital-to-analog converter 22 may receive the second column data having a preset fixed value and output the second column signal T having a fixed level to the backlight board 40.

The backlight driving board 6 may include a memory 14. The microcontroller 10 may store the backlight data for one frame in the memory 14, read the backlight data stored in the memory 14 in units of horizontal periods, and provide the first column data and the second column data.

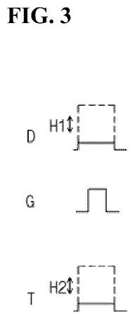

The first column signal D and the second column signal T output from the digital-to-analog converters 20 and 22 and the row signal G output from the microcontroller 10 can be understood with reference to FIG. 3.

Referring to FIG. 3, the first column signal D can be understood as a pulse having a uniform pulse width and may have a level for the linear control in response to the value of the first column data. For example, in response to the first column data with high luminance, the first column signal D may have a high level of amplitude H1. On the other hand, in response to the first column data with low luminance, the first column signal D may have a low level of amplitude H1. That is, the level of the first column signal D may vary depending on the value of the first column data.

The second column signal T may also be understood as a pulse having a uniform pulse width and may have a level for the pulse width control in response to the value of the second column data. For example, in response to the second column data with high luminance, the second column signal T may have a high level of amplitude H2 in order to generate a control pulse having a wide pulse width. On the other hand, in response to the second column data with low luminance, the second column signal T may have a low level of amplitude H2 in order to generate a control pulse having a narrow pulse width. That is, the level of the second column signal T may vary depending on the value of the second column data.

The first column signal D and the second column signal T may be provided to have the same pulse width at the same timing.

Preferably, the row signal G is output to have a narrower pulse width than the first column signal D and the second column signal T, and is activated during the period in which the first column signal D and the second column signal T are activated.

The backlight board 40 is configured to receive the first column signal D, the second column signal T, the row signal G, and the driving voltage VLED. The backlight board 40 is configured to control the light emission of each light emitting block to have luminance corresponding to the first column signal D and the second column signal T in response to the row signal G, and to provide a backlight by the light emission of each light emitting block. The driving voltage VLED may be transmitted to the backlight board 40 through the backlight driving board 6 and applied to each light emitting block.

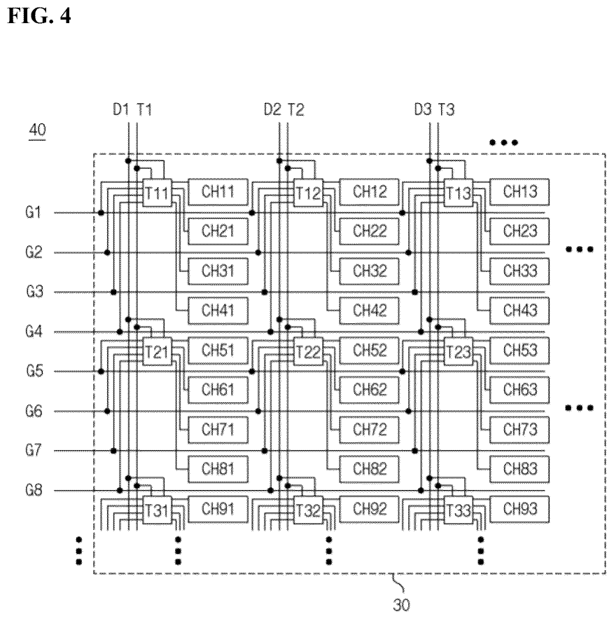

The configuration of the backlight board 40 is described in detail with reference to FIG. 4.

The backlight board 40 may include light emitting blocks and current control integrated circuits. In FIG. 4, the light emitting blocks are indicated by “CH11 to CH93” and the current control integrated circuits are indicated by “T11 to T33”.

In the backlight board 40, an area where the light emitting blocks CH11 to CH93 and the current control integrated circuits T11 to T33 are formed may be defined as a backlight area 30. The backlight area 30 can be understood as an area for providing a backlight by light emission of the light emitting blocks CH11 to CH93.

Each light emitting block is a basic unit for controlling dimming. Each light emitting block can be understood as including at least one light emitting diode LED formed in a preset zone on the backlight board 40. That is, the light emitting block can be understood as a light source using an LED.

With the above configuration, the backlight board 40 is configured to serve as a surface light source in which light sources are collected.

In the backlight board 40, the light emitting blocks CH11 to CH93 form columns and rows, and may be arranged in a matrix structure, for example. Each of the light emitting blocks CH11 to CH93 can be understood as including a plurality of LEDs connected in series.

The light emitting blocks CH11 to CH93 may be grouped into a plurality of control units. The control unit may be arranged in the same column or an adjacent column and set to include a plurality of rows, and can be understood as including a predetermined number of light emitting blocks that sequentially emit light according to a horizontal period.

In the backlight board 40 of FIG. 4, each control unit is illustrated as including light emitting blocks arranged continuously across a plurality of rows on the same column.

More specifically, each control unit may be illustrated as including four light emitting blocks that are consecutively arranged in the same column and emit light sequentially. That is, the light emitting blocks CH11, CH21, CH31, and CH41, the light emitting blocks CH51, CH61, CH71, and CH81, the light emitting blocks CH12, CH22, CH32, and CH42, the light emitting blocks CH52, CH62, CH72, and CH82, the light emitting blocks CH13, CH23, CH33, and CH43, and the light emitting blocks CH53, CH63, CH73, and CH83 may each be grouped into one control unit.

The current control integrated circuits T11, T12, T13, T21, T22, T23, T31, T32, and T33 are each configured to correspond to one control unit.

More specifically, the current control integrated circuit T11 is configured to control driving currents of the light emitting blocks CH11, CH21, CH31, and CH41, the current control integrated circuit T21 is configured to control driving currents of the light emitting blocks CH51, CH61, CH71, and CH81, the current control integrated circuit T12 is configured to control driving currents of the light emitting blocks CH12, CH22, CH32, and CH42, the current control integrated circuit T22 is configured to control driving currents of the light emitting blocks CH52, CH62, CH72, and CH82, the current control integrated circuit T13 is configured to control driving currents of the light emitting blocks CH13, CH23, CH33, and CH43, and the current control integrated circuit T23 is configured to control driving currents of the light emitting blocks CH53, CH63, CH73, and CH83.

The current control integrated circuits T11, T12, T13, T21, T22, T23, T31, T32, and T33 are each configured to receive the first column signal D, the second column signal T, and the row signal G of the backlight driving board 6. The first column signal D corresponds to the first column signals D1, D2, D3 . . . in FIG. 4, the second column signal T corresponds to the second column signals T1, T2, T3 . . . in FIG. 4, and the row signal G corresponds to the row signals G1, G2, G3 . . . in FIG. 4.

The backlight board 40 provides a backlight with a resolution determined by all the light emitting blocks CH11 to CH93. One frame of the backlight corresponds to one frame of an image displayed on the display panel 4 and includes a plurality of horizontal periods. In such a case, the number of horizontal periods included in one frame of the backlight may be different from the number of horizontal periods included in one frame of the image.

The first column signals D1, D2, D3 . . . and the second column signals T1, T2, T3 . . . may be provided for every horizontal period. Signal lines to which the first column signals D1, D2, D3 . . . are applied may be referred to as first column lines, and signal lines to which the second column signals T1, T2, T3 . . . are applied may be referred to as second column lines.

The row signals G1, G2, G3 . . . may be sequentially provided one by one according to the horizontal period. Signal lines to which the row signals G1, G2, G3 . . . are applied may be referred to as row lines.

With the above configuration, the current control integrated circuits T11, T12, T13, T21, T22, T23, T31, T32, and T33 may each receive the first column signal, the second column signal, and the row signal of a control unit to which each of the current control integrated circuits T11, T12, T13, T21, T22, T23, T31, T32, and T33 corresponds.

To this end, the current control integrated circuits T11, T21, and T31 are configured to share the first column line for receiving the first column signal D1 and the second column line for receiving the second column signal T1. The current control integrated circuits T12, T22, and T32 are configured to share the first column line for receiving the first column signal D2 and the second column line for receiving the second column signal T2. The current control integrated circuits T31, T23, and T33 are configured to share the first column line for receiving the first column signal D3 and the second column line for receiving the second column signal T3.

Each of the current control integrated circuits T11, T12, T13, T21, T22, T23, T31, T32, and T33 receives row signals corresponding to its control unit. Current control integrated circuits belonging to a control unit of the same row location share row lines and are configured to receive the same row signals.

Each of the current control integrated circuits T11, T12, T13, T21, T22, T23, T31, T32, and T33 may receive the first column signal, the second column signal, and the row signals corresponding to its control unit, control the driving currents of light emitting blocks in the control unit, and as a consequence, control the light emission of the light emitting blocks. For example, the current control integrated circuit T11 may receive the first column signal D1, the second column signal T1, and the row signals G1 to G4, control the driving currents of the light emitting blocks CH11, CH21, CH31, and CH41, and as a consequence, control the light emission of the light emitting blocks CH11, CH21, CH31, and CH41.

Each of the current control integrated circuits T11, T12, T13, T21, T22, T23, T31, T32, and T33 is configured to generate sampling voltages by sequentially sampling the horizontal period-by-horizontal period first column signal and second column signal by using the row signals. Subsequently, each of the current control integrated circuits T11, T12, T13, T21, T22, T23, T31, T32, and T33 may control the maintenance of light emission and brightness of the light emitting blocks in the control unit by using the sampling voltages. For example, the current control integrated circuit T11 generates sampling voltages by sampling horizontal period-by-horizontal period first column signal D1 and second column signal T1 by using the row signals G1 to G4 sequentially provided according to the horizontal period, and controls driving currents for light emission of the light emitting blocks CH11, CH21, CH31, and CH41 belonging to the control unit by using sampling voltages. That is, the current control integrated circuit T11 may control the maintenance of light emission and brightness of the light emitting blocks CH11, CH21, CH31, and CH41.

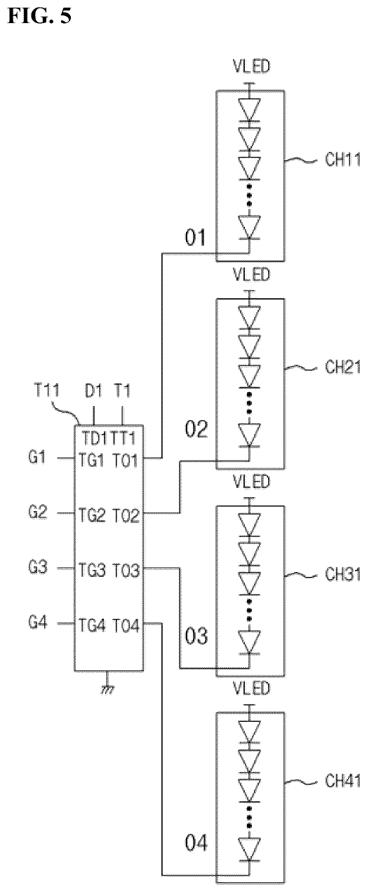

The connection of each of the current control integrated circuits T11, T12, T13, T21, T22, T23, T31, T32, and T33 and light emitting blocks in a corresponding control unit can be understood with reference to FIG. 5. FIG. 5 illustrates the connection of the current control integrated circuit T11 and the light emitting blocks CH11, CH21, CH31, and CH41 in the control unit corresponding to the current control integrated circuit T11.

FIG. 5 illustrates an example in which the current control integrated circuit T11 includes a first column input terminal TD1, a second column input terminal TT1, row input terminals TG1 to TG4, and control terminals T01 to T04. The current control integrated circuit T11 receives the first column signal D1 through the first column input terminal TD1, receives the second column signal T1 through the second column input terminal TT1, receives the row signals G1 to G4 through the row input terminals TG1 to TG4, and receives driving currents 01 to 04 of the light emitting blocks CH11, CH21, CH31, and CH41 through the control terminals T01 to T04.

Each of the light emitting blocks CH11, CH21, CH31, and CH41 receives the driving voltage VLED and includes a plurality of LEDs connected in series. The driving currents 01 to 04 on low sides of the light emitting blocks CH11, CH21, CH31, and CH41 are input to the control terminals T01 to T04 of the current control integrated circuit T11.

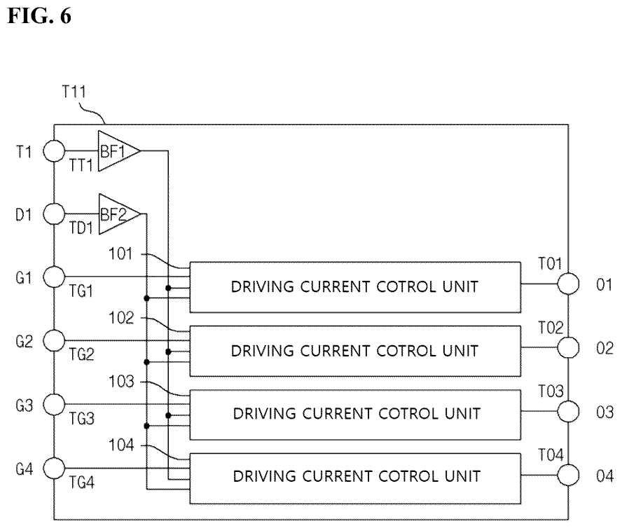

Each of the current control integrated circuits T11, T12, T13, T21, T22, T23, T31, T32, and T33 may include buffers BF and driving current control units 101 to 104. The configuration of each of the current control integrated circuits T11, T12, T13, T21, T22, T23, T31, T32, and T33 can be understood with reference to the configuration of the current control integrated circuit T11 in FIG. 6.

The current control integrated circuit T11 includes a buffer BF1 that receives the first column signal D1 shared with the first column line and a buffer BF2 that receives the second column signal T1 shared with the second column line.

The current control integrated circuit T11 may include the driving current control units 101 to 104 that receive the row signals G1 to G4 input through the plurality of rows, respectively, and share the first column signal D1 and the second column signal T1 received through the buffers BF1 and BF2.

The buffers BF1 and BF2 may form offset voltages Doffset and Toffset for the first column signal D1 and the second column signal T1.

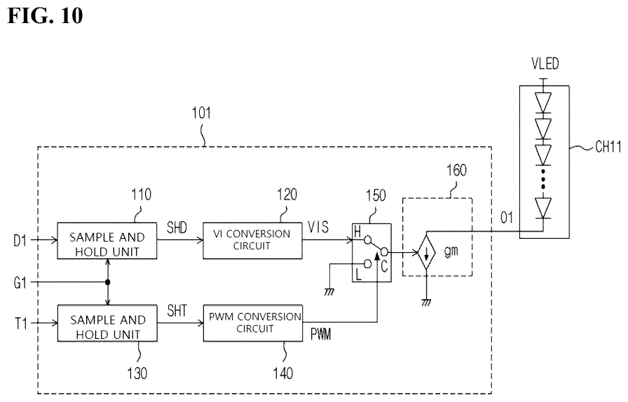

Each of the driving current control units 101 to 104 may be configured to control the amount of driving current for light emission of a light emitting block corresponding to its row signal so as to correspond to the level of the first column signal D1 and the level of the second column signal T1. The configuration and operation of the driving current control units 101 to 104 described below are described in detail with reference to FIG. 10.

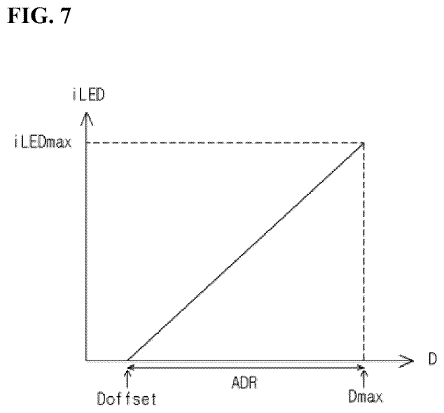

An amplitude change, that is, a level change, due to the first column signal D may be described with reference to FIG. 7. FIG. 7 illustrates a change in a driving current iLED according to a change in the level of the first column signal D1 without considering the second column signal T1. In FIG. 7, the driving current is indicated by iLED for convenience of description.

In FIG. 7, the offset voltage Doffset can be understood as being formed by the buffer BF1 that receives the first column signal D1, and the light emitting block CH11 is extinguished in response to the first column signal D1 at a level below the offset voltage Doffset.

When the light emission of the light emitting block CH11 is controlled by the first column signal D1, the light emitting block CH11 may emit light in response to the level of the first column signal D1 corresponding to a light emission range ADR between a maximum value Dmax and the offset voltage Doffset.

When the level of the first column signal D1 increases from the offset voltage Doffset to the maximum value Dmax in the light emission range ADR, the amount of driving current iLED of the light emitting block CH11 may be controlled to increase from a minimum value to a maximum value iLEDmax. It can be understood that the luminance of the light emitting block CH11 increases in proportion to the amount of driving current iLED. That is, the level of the first column signal D1 has a relationship proportional to the amount of the driving current iLED, that is, the luminance of the light emitting block CH11 in the light emission range ADR.

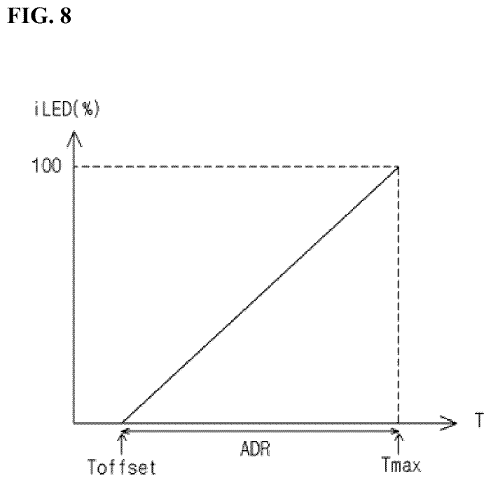

In addition, an amplitude change, that is, a level change, in the second column signal T1 may be described with reference to FIG. 8. FIG. 8 illustrates a change in the driving current iLED according to a pulse width change caused by the level of the second column signal T1 without considering the first column signal D1. Also in FIG. 8, the driving current is indicated by iLED for convenience of description.

In FIG. 8, the offset voltage Toffset can be understood as being formed by the buffer BF2 that receives the second column signal T1, and the light emitting block CH11 is extinguished in response to the second column signal T1 at a level below the offset voltage Doffset.

When the light emission of the light emitting block CH11 is controlled by the second column signal T1, the light emitting block CH11 may emit light in response to the level of the second column signal T1 corresponding to a light emission range ADR between the maximum value Dmax and the offset voltage Toffset.

When the level of the second column signal T1 increases from the offset voltage Toffset to the maximum value Tmax in the emission range ADR, the pulse width of a control pulse PWM for controlling the driving current also increases from a minimum value to a maximum value, and correspondingly, the amount of driving current iLED of the light emitting block CH11 may be controlled to increase from the minimum value to the maximum value 100%. That is, the level of the second column signal T1 and the pulse width of the control pulse PWM controlled by the second column signal T1 have a relationship proportional to the amount of the driving current iLED, that is, the luminance of the light emitting block CH11 in the light emission range ADR.

In FIG. 6, the driving current control units 101 to 104 are configured to correspond to the light emitting blocks CH11, CH21, CH31, and CH41 of the corresponding control unit thereof.

The driving current control units 101 to 104 may receive the row signals G1 to G4 through the row input terminals TG1 to TG4, respectively, and receive the first column signal D1 and the second column signal T1 through the buffers BF and BF2. The driving current control units 101 to 104 may control the amount of driving currents 01 to 04 of the light emitting blocks CH11, CH21, CH31, and CH41 through the control terminals T01 to T04.

More specifically, the driving current control unit 101 may be configured to receive the row signal G1, sample the first column signal D1 and the second column signal T1 by using the row signal G1, and control the amount of driving current 01 for light emission of the light emitting block CH11 to correspond to a pulse width corresponding to a level of a first sampled signal obtained by sampling the first column signal D1 and a level of a second sampled signal obtained by sampling the second column signal T1. The driving current control unit 102 may be configured to receive the row signal G2, sample the first column signal D1 and the second column signal T1 by using the row signal G2, and control the amount of driving current 02 for light emission of the light emitting block CH21 to correspond to the pulse width corresponding to the level of the first sampled signal obtained by sampling the first column signal D1 and the level of the second sampled signal obtained by sampling the second column signal T1. The driving current control unit 103 may be configured to receive the row signal G3, sample the first column signal D1 and the second column signal T1 by using the row signal G3, and control the amount of driving current 03 for light emission of the light emitting block CH31 to correspond to the pulse width corresponding to the level of the first sampled signal obtained by sampling the first column signal D1 and the level of the second sampled signal obtained by sampling the second column signal T1. The driving current control unit 104 may be configured to receive the row signal G4, sample the first column signal D1 and the second column signal T1 by using the row signal G4, and control the amount of driving current 04 for light emission of the light emitting block CH41 to correspond to the pulse width corresponding to the level of the first sampled signal obtained by sampling the first column signal D1 and the level of the second sampled signal obtained by sampling the second column signal T1.

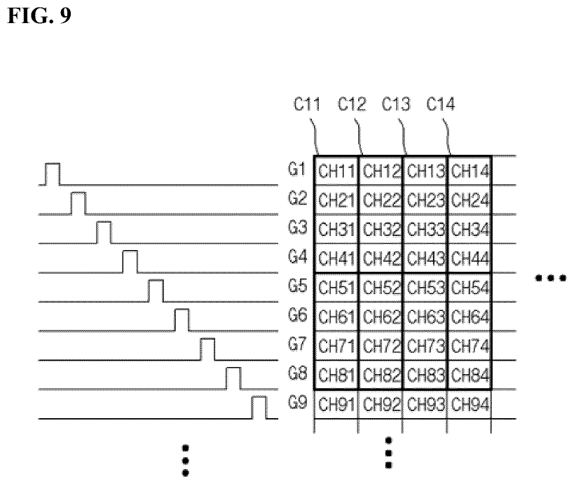

FIG. 9 illustrates the arrangement of the light emitting blocks and the division of the control units. FIG. 9 illustrates a control unit C11 including the light emitting blocks CH11, CH21, CH31, and CH41, a control unit C12 including the light emitting blocks CH12, CH22, CH32, and CH42, a control unit C13 including the light emitting blocks CH13, CH23, CH33, and CH43, and a control unit C14 including the light emitting blocks CH14, CH24, CH34, and CH44.

The configurations of the driving current control units 101 to 104 in FIG. 6 may be described in detail with reference to FIG. 10. FIG. 10 illustrates the driving current control unit 101, and the configurations of the remaining driving current control units 102 to 104 can be understood with reference to the driving current control unit 101.

Referring to FIG. 10, the driving current control unit 101 is configured to generate a first sampled signal SHD by sampling the first column signal D1 by using the row signal G1 and a second sampled signal SHT by sampling the second column signal T1 by using the row signal G1, to generate a control signal VIS having a current amount corresponding to the first sampled signal SHD and a control pulse PWM corresponding to the second sampled signal SHT, and to control the amount of the driving current 01 by using the control signal VIS transmitted with a current amount controlled by the control pulse PWM.

To this end, the driving current control unit 101 is illustrated as including sample and hold units 110 and 130, a voltage current conversion circuit 120, a pulse width conversion circuit 140, a switch 150, and a driver 160. The voltage current conversion circuit 120 is expressed as a VI conversion circuit 120 and the pulse width conversion circuit 140 is expressed as a PWM conversion circuit.

The sample and hold unit 110 may be configured to generate the first sampled signal SHD by sampling the first column signal D1 by using the row signal G1, and output the first sampled signal SHD.

The sample and hold unit 110 generates the first sampled signal SHD by sampling the first column signal D1 while the row signal Gl is enabled. In such a case, the level of the first sampled signal SHD may be formed to correspond to the level of the first column signal D1. That is, the level of the first sampled signal SHD may be formed to be proportional to the level of the first column signal D1.

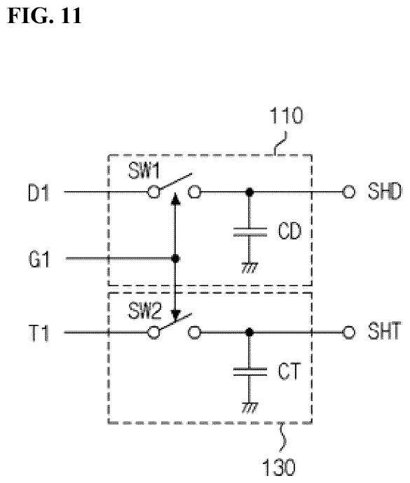

The sample and hold unit 110 may include a switch SW1 and a capacitor CD as illustrated in FIG. 11. The switch SW1 is configured to switch the output of the first column signal D1 after its switching is controlled by the row signal G1. The capacitor CD is configured in parallel to an output terminal of the switch SW1 and is configured to generate the first sampled signal SHD by sampling the first column signal D1 output through the switch SW1 and provide the first sampled signal SHD.

The sample and hold unit 130 may be configured to generate the second sampled signal SHT by sampling the second column signal T1 in response to the row signal G1, and output the second sampled signal SHT.

The sample and hold unit 130 generates the second sampled signal SHT by sampling the second column signal T1 while the row signal G1 is enabled. In such a case, the level of the second sampled signal SHT may be formed to correspond to the pulse level of the second column signal T1. That is, the level of the second sampled signal SHT may be formed to be proportional to the pulse level of the second column signal T1.

The sample and hold unit 130 may include a switch SW2 and a capacitor CT as illustrated in FIG. 11. The switch SW2 is configured to switch the output of the second column signal T1 after its switching is controlled by the row signal G1. The capacitor CT is configured in parallel to an output terminal of the switch SW2 and is configured to generate the second sampled signal SHT by sampling the second column signal T1 output through the switch SW2 and provide the second sampled signal SHT.

The sample and hold units 110 and 130 may be configured to sample the first column signal D1 and the second column signal T1 by charging, respectively, and to have a charging time sufficient for sampling by the row signal G1. The sample and hold unit 110 may be configured to output a charged voltage as the first sampled signal SHD, and the sample and hold unit 130 may be configured to output a charged voltage as the second sampled signal SHT. The sampling of the sample and hold units 110 and 130 may be simultaneously performed by the shared row signal G1.

The VI conversion circuit 120 may be configured to generate and output the control signal VIS having a current amount corresponding to the voltage level of the first sampled signal SHD. The VI conversion circuit 120 described above may be configured using a dependent current source (not illustrated) that controls an output current by the first sampled signal SHD.

The PWM conversion circuit 140 may be configured to generate and output the control pulse PWM corresponding to the second sampled signal SHT.

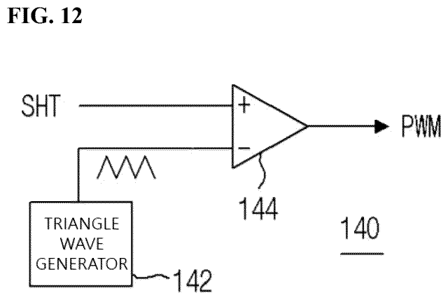

The PWM conversion circuit 140 may be configured as illustrated in FIG. 12, for example. Referring to FIG. 12, the PWM conversion circuit 140 may include a triangle wave generator 142 and a comparator 144. The triangle wave generator 142 is used to provide a triangle wave having a preset frequency and amplitude.

The comparator 144 receives the second sampled signal SHT through a positive terminal+ and receives the triangle wave of the triangle wave generator 142 through a negative terminal−. With the above configuration, the comparator 144 may compare the triangle wave and the second sampled signal SHT, and output the control pulse PWM having a high-level pulse width for enabling during the period in which the triangle wave has a lower level than the second sampled signal SHT. That is, when a high level of the second sampled signal SHT is formed, the duty ratio, that is, the pulse width, of the control pulse PWM increases, and when a low level of the second sampled signal SHT is formed, the duty ratio, that is, the pulse width, of the control pulse PWM decreases.

The switch 150 is configured to switch transmission of the control signal VIS by the control pulse PWM.

To this end, the switch 150 may include an input terminal H to which the control signal VIS of the VI conversion circuit 120 is input, an input terminal L to which a ground voltage is applied, and an output terminal C for outputting the control signal VIS switched by the control pulse PWM.

The switch 150 connects the input terminal H and the output terminal C during the high-level pulse width duration of the control pulse PWM to output the control signal VIS to the driver 160, and connects the input terminal L and the output terminal C during the low level duration of the control pulse PWM to stop output of the control signal VIS.

That is, the current amount of the control signal VIS provided to the driver 160 through the switch 150 is controlled by the pulse width of the control pulse PWM.

As a consequence, the switch 150 may provide the driver 160 with current amount corresponding to the result of operating the control signal VIS corresponding to the level of the first column signal D1 and the control pulse PWM having a pulse width corresponding to the level of the second column signal T1.

The driver 160 is configured to amplify the amount of a current transmitted through the switch 150 to control the amount of the driving current 01 for light emission of the light emitting block CH11.

To this end, the driver 160 may include a dependent current source gm connected to a low side of the light emitting block CH11, and the dependent current source gm may control the amount of the driving current 01 to be proportional to the current amount of the control signal VIS controlled by the control pulse PWM.

The embodiments of the present disclosure can be operated in one mode among the linear control, the pulse width control, and the composite control, and the above operation may be selected by providing the dimming mode command I2C having a value corresponding to each mode to the microcontroller 10.

In the case of the linear control, in response to the dimming mode command I2C, the microcontroller 10 may provide the digital-to-analog converter 20 with the first column data for the linear control, and provide the digital-to-analog converter 22 with the second column data having a preset value for the linear control instead of column data of backlight data of a corresponding horizontal period. The digital-to-analog converter 22 may output the second column signal T having a preset fixed level, such as a high level, based on the second column data having a preset value. In such a case, the switch 150 of the driving current control unit 101 remains turned on. Therefore, the switch 150 may transmit the control signal VIS of the VI conversion circuit 120 to the driver 160 as is. As a consequence, the driver 160 may control the amount of the driving current 01 for light emission to correspond to the level of the first column signal D of the digital-to-analog converter 20. In the case of the linear control described above, a change in the amount of the driving current 01 for light emission can be understood with reference to FIG. 7.

In the case of the pulse width control, in response to the dimming mode command I2C, the microcontroller 10 may provide the digital-to-analog converter 20 with the first column data having a preset value for the pulse width control instead of column data of backlight data of a corresponding horizontal period. The digital-to-analog converter 20 may output the first column signal D having a preset fixed level, such as a high level, based on the first column data having a preset value. In such a case, in the driving current control unit 101, the VI conversion circuit 120 may provide the control signal VIS having a fixed current amount corresponding to the first column signal D1 at a fixed level, and the switch 150 may switch to transmit the control signal VIS of the VI conversion circuit 120 to the driver 160 by the control pulse PWM having a pulse width corresponding to the column data of the corresponding horizontal period. As a consequence, the driver 160 may control the driving current 01 for light emission to correspond to the level of the second column signal T of the digital-to-analog converter 22. In the case of the pulse width control described above, a change in the amount of the driving current 01 for light emission can be understood with reference to FIG. 8.

In the case of the composite control, in response to the dimming mode command I2C, the microcontroller 10 may provide the digital-to-analog converters 20 with column data of backlight data of a corresponding horizontal period as the first column data and the second column data. The digital-to-analog converters 20 and 22 may output the first column signal D and the second column signal T with levels corresponding to the first column data and the second column data. When the luminance of the column data of the backlight data of the corresponding horizontal cycle is high, the microcontroller 10 may provide the value of the first column data provided to the digital-to-analog converter 20 to be equal to or lower than the value of original column data and provide the value of the second column data provided to the digital-to-analog converter 22 to be higher than the value of the original column data in order to eliminate the occurrence of a flicker. When the luminance of the column data of the backlight data of the corresponding horizontal period is low, the microcontroller 10 may provide the value of the first column data provided to the digital-to-analog converter 20 to be higher than the value of the original column data and provide the value of the second column data provided to the digital-to-analog converter 22 to be equal to or lower than the value of the original column data for the purpose of precise dimming control. When the luminance of the column data of the backlight data of the corresponding horizontal period is at a medium level, the microcontroller 10 may provide the first column data and the second column data provided to the digital-to-analog converters 20 and 22 with the same value as the value of the original column data. As a consequence, the levels of the first column signal D and the second column signal T output from the digital-to-analog converters 20 and 22 may be the same as or different from each other for the purpose of dimming control according to luminance.

In the case of the composite control described above, in the driving current control unit 101, the VI conversion circuit 120 provides the control signal VIS having a current amount corresponding to the first column signal D, and the PWM conversion circuit 140 provides the control pulse PWM having a pulse width corresponding to the first column signal T. The switch 150 switches the control signal VIS with a pulse width corresponding to the duty of the control pulse PWM and transmits a current having an amount corresponding to the switching result to the driver 160. As a consequence, the driver 160 may control the driving current 01 for light emission to correspond to the result of combining the first column signal D of the digital-to-analog converter 20 and the second column signal T of the digital-to-analog converter 22.

According to the above-described embodiments of the present disclosure, light emitting blocks for providing a backlight can maintain light emission for one frame or more, and a backlight with a reduced or eliminated flicker can be provided to an LCD panel for a display.

In addition, the present disclosure groups light emitting blocks for providing a backlight to an LCD panel into a plurality of control units and controls a driving current for dimming control for each light emitting block in the control unit, thereby simplifying the configuration of a backlight device for a display and efficiently controlling dimming.

In addition, the present disclosure has the advantage of being able to control dimming by using various modes such as linear control, pulse width control, and composite control.

In addition, in the present disclosure, the amount of driving current can be complexly controlled by the level of a control signal corresponding to the level of a first column signal and the pulse width of a control pulse corresponding to the level of a second column signal. In particular, the present disclosure can also be expected to have the effect that the amount of the driving current can be controlled uniformly and precisely in a luminance change area where the luminance of a backlight is low, and can be controlled to prevent a flicker in a luminance change area where the luminance of the backlight is high.

What is claimed is:

1. A backlight device for a display, comprising:
a backlight driving board configured to generate frame-unit backlight data for a backlight and to provide, for each horizontal period, a first column signal and a second column signal having a level corresponding to column data of the backlight data and a row signal corresponding to the horizontal period; and
a backlight board configured to provide the backlight by the first column signal, the second column signal, and the row signal provided for each horizontal period,
wherein the backlight board comprises:
light emitting blocks configured to form columns and rows and to be grouped into a plurality of control units each comprising a plurality of rows; and
current control integrated circuits configured for each control unit and each comprising a plurality of driving current control units configured to receive the first column signal and the second column signal shared by the light emitting blocks of a same column and the row signals corresponding to the plurality of rows, respectively,
wherein the driving current control unit samples the first column signal and the second column signal by using the row signal, and controls an amount of driving current for light emission of the light emitting block to correspond to a pulse width corresponding to a level of a first sampled signal obtained by sampling the first column signal and a level of a second sampled signal obtained by sampling the second column signal.

2. The backlight device for a display of claim 1, wherein the backlight driving board receives frame-unit luminance data corresponding to display data,
generates the frame-unit backlight data for the backlight by using the luminance data,
generates the first column signal for linear control and the second column signal for pulse width control for each horizontal period of the backlight data,
generates the row signal for each horizontal period, and
provides the first column signal, the second column signal, and the row signal.

3. The backlight device for a display of claim 2, wherein the backlight driving board receives a dimming mode command for defining one of the linear control, the pulse width control, and composite control, and
in response to the dimming mode command, the backlight driving board provides the first column signal to have a level corresponding to luminance of the backlight and provides the second column signal to have a preset fixed level for the purpose of the linear control, provides the first column signal to have the preset fixed level and provides the second column signal to have the level corresponding to the luminance of the backlight for the purpose of the pulse width control, and provides the first column signal and the second column signal to have the level corresponding to the luminance of the backlight for the purpose of the composite control.

4. The backlight device for a display of claim 1, wherein the backlight driving board comprises:
a microcontroller configured to receive frame-unit luminance data corresponding to display data, to generate the frame-unit backlight data for the backlight by using the luminance data, and to output the horizontal period-by-horizontal period row signal of the frame and first column data and second column data corresponding to the horizontal period-by-horizontal period column data of the backlight data;
a first digital-to-analog converter configured to receive the first column data and output the first column signal having a level corresponding to the first column data; and
a second digital-to-analog converter configured to receive the second column data and output the second column signal having a level corresponding to the second column data.

5. The backlight device for a display of claim 4, wherein the backlight driving board further comprises a memory, and
the microcontroller stores the backlight data for one frame in the memory, reads the backlight data of the memory in units of horizontal periods, and provides the first column data and the second column data.

6. The backlight device for a display of claim 4, wherein the microcontroller receives a dimming mode command for defining one of the linear control, the pulse width control, and composite control, and
in response to the dimming mode command, the microcontroller provides the first column data corresponding to the horizontal period-by-horizontal period column data of the backlight data and the second column data having a preset value for the purpose of the linear control, provides the first column data having a preset value and the second column data corresponding to the horizontal period-by-horizontal period column data of the backlight data for the purpose of the pulse width control, and provides the first column data and the second column data corresponding to the horizontal period-by-horizontal period column data of the backlight data for the purpose of the composite control.

7. The backlight device for a display of claim 1, wherein the driving current control unit generates the first sampled signal by sampling the first column signal by using the row signal and the second sampled signal by sampling the second column signal by using the row signal,
generates a control signal having a current amount at a level corresponding to the first sampled signal and a control pulse having a pulse width corresponding to the second sampled signal, and
controls the amount of the driving current by using the control signal having the current amount controlled by the control pulse.

8. The backlight device for a display of claim 1, wherein the driving current control unit comprises:
a first sample and hold unit configured to generate the first sampled signal by sampling the first column signal by using the row signal;
a second sample and hold unit configured to generate the second sampled signal by sampling the second column signal by using the row signal;
a voltage current conversion circuit configured to generate a control signal having a current amount corresponding to the level of the first sampled signal;
a PWM conversion circuit configured to generate a control pulse having the pulse width corresponding to the level of the second sampled signal;
a switch configured to switch transmission of the control signal by the control pulse; and
a driver configured to control the amount of the driving current for light emission of the light emitting block by the control signal transmitted through the switch.

9. The backlight device for a display of claim 8, wherein the driver comprises a dependent current source connected to a low side of the light emitting block, and the dependent current source controls the amount of the driving current to be proportional to the current amount of the control signal transmitted through the switch.

10. A current control integrated circuit of a backlight device for a display, comprising:
a plurality of driving current control units configured to correspond to light emitting blocks in control units each comprising a plurality of rows, to share a first column signal and a second column signal with respect to a same column, and to receive different row signals,
wherein each of the driving current control units samples the first column signal and the second column signal by using the row signal, and
controls an amount of driving current for light emission of the light emitting block to correspond to a pulse width corresponding to a level of a first sampled signal obtained by sampling the first column signal and a level of a second sampled signal obtained by sampling the second column signal.

11. The current control integrated circuit of a backlight device for a display of claim 10, wherein the driving current control unit generates the first sampled signal by sampling the first column signal by using the row signal and the second sampled signal by sampling the second column signal by using the row signal,
generates a control signal having a current amount at a level corresponding to the first sampled signal and a control pulse having a pulse width corresponding to the second sampled signal, and
controls the amount of the driving current by using the control signal having the current amount controlled by the control pulse.

12. The current control integrated circuit of a backlight device for a display of claim 10, wherein the driving current control unit comprises:
a first sample and hold unit configured to generate the first sampled signal by sampling the first column signal by using the row signal;
a second sample and hold unit configured to generate the second sampled signal by sampling the second column signal by using the row signal;
a voltage current conversion circuit configured to generate a control signal having a current amount corresponding to the level of the first sampled signal;
a PWM conversion circuit configured to generate a control pulse having the pulse width corresponding to the level of the second sampled signal;
a switch configured to switch transmission of the control signal by the control pulse; and
a driver configured to control the amount of the driving current for light emission of the light emitting block by the control signal transmitted through the switch.

13. The current control integrated circuit of a backlight device for a display of claim 12, wherein the driver comprises a dependent current source connected to a low side of the light emitting block, and the dependent current source controls the amount of the driving current to be proportional to the current amount of the control signal transmitted through the switch.
